(19) United States
(12) Patent Application Publication
(10) Pub. No.: US 2003/0182845 A1
(43) Pub. Date: Oct. 2, 2003

(54) Apparatus for fly and tippet storage

(76) Inventor: John L. Pfeffer, Woodland Park, CO (US)

Correspondence Address: Glen F. Gallinger, 7420 Milner Dr., #1000, Colorado Springs, CO, 80920, US

(21) Appl. No.: 10/107,975

(22) Filed: Mar. 28, 2002

(51) Int. Cl. A01K 97/06

(52) U.S. Cl. 43/57.1

(57) ABSTRACT

Multiple leaves and a binder which are particularly adapted to conveniently and accessibly store, organize, and display pre-tied flies and tippets. The flies are tied on a fishing hook which has a pointed end portion, and an eye to which the tippet is pre-tied in advance of active use. A first leaf comprises: a hook reception member having a thickness sufficient to receive the pointed end portion of the hook, and two opposite sides, one opposite side of which is adhered to a front side portion of the first leaf. The pointed end portion of the fishing hook may be first hooked into the thickness of the hook reception block, and then the tippet may be wound around the leaf. An alternative embodiment of the invention comprises a second leaf having a fly reception opening cut from the front side portion through the thickness of the second leaf; and, a hook reception member extending through and across the opening so that the fishing hook may be pulled over and around the hook reception member, and then the tippet may be wound around the leaf.

### FIELD OF THE INVENTION

This invention relates to the storage of pre-tied flies and tippets used in fly fishing. More particularly this invention relates to a binder having multiple leaves which are particularly adapted to conveniently and accessibly store, organize, and display pre-tied flies and tippets.

### BACKGROUND OF THE INVENTION

One of the most important, and most deliberated decisions in fly fishing is the selection of the best fly to fish with. To choose the best fly for a particular location in a given fishing site, the water movement and depth, the lighting and presence of vegetation, as well as the weather at a particular time of day, are among the factors reckoned. Typically the selection of the best fly is made at the particular fishing location from the fisherman's complete collection of flies. The flies are carried by the fisherman in his hat, his vest, or in a number of boxes.

A fly is tied to a hook. A tippet is threaded through the small eye on the hook and is secured therethrough with one of several difficult to tie knots. Tippet material normally used in fresh water fly fishing ranges from 0.013 to 0.003″ in diameter. Tippet lengths vary from approximately 10 to 20″. A selected fly and tippet are snapped to a tapered leader of transparent plastic. The leader is attached to a weighted and lubricated fly line. A pole and reel are used to cast the fly to a target area.

After a first fly and tippet have been selected and fished with; it is usual practice to replace the fly and tippet. A replacement may be made when the fly is damaged, snagged or otherwise lost with a fish which could not be landed. But just as often, the fly may be replaced, simply in hopes of improving one's luck with another fly which may better attract fish.

To replace the fly, the fisherman must hold his rod under one arm or tucked into his waders; he must hold the end of the leader to prevent the rod from coming unthreaded; and then, he must cut the fly from the end of the tippet. After the fly is replaced into a storage container, he selects, and removes, a replacement fly. And next, sometimes while standing in a moving stream on a slippery rock bottom under varying conditions of light and temperature, he must thread the nearly invisible tippet through the equally small eye of the fly. Subsequently, the fly must be tied, and the excess tippet must be trimmed off as close as possible to the fly. And additionally, if the fly was lost due to a break off, a spool of tippet material must be retrieved to restore the tippet to its proper length before tying on the fly. A substantial portion of the time spent in a stream or on a bank is spent in unproductive “rigging up” without a fly in the water. Moreover, this unproductive time spent is sometimes trying, frustrating, and exhausting—in marked contrast to the purpose of the fishing expedition.

### OBJECTS OF THE INVENTION

It is an object of this invention to disclose an apparatus comprising a lightweight storage binder having removable leaves which conveniently organizes, displays, and stores both flies and tippets tied thereto. It is an object of this invention to disclose a method of storing both flies and tippets tied thereto, which facilitates organization thereof, and selection therefrom, so that flies could be conveniently removed therefrom for a particular occasion, and conveniently carried while fishing. It is an object of this invention to disclose a storage binder which conveniently stores both flies and tippets tied thereto, thereby allowing tippets of proper lengths and weights, to be tied to flies advance, under controlled conditions, before arriving on a fishing site. It is yet a further object of this invention to disclose arrangements for binder leaves which facilitate convenient access and organization of fishing flies thereon. It is a final object of this invention to make fly fishing more productive and more enjoyable.

One aspect of this invention provides for a first leaf for storage and display of a fishing fly and tippet. The fly is tied on a fishing hook having a pointed end portion, and an eye to which the tippet is pre-tied in advance of active use. The leaf comprises: a leaf having a length and width; and, a hook reception member having a thickness sufficient to receive the pointed end portion of the hook, and two opposite sides, one opposite side of which is adhered to the front side portion of the first leaf. The pointed end portion of the fishing hook may be first hooked into the thickness of the hook reception block, and then the tippet may be wound around the leaf.

In an other aspect of the invention a second leaf has a fly reception opening cut from the front side portion through the thickness of the leaf; and, a hook reception member extending through and across the opening. With this arrangement the fishing hook may be pulled over and around the hook reception member, and then the tippet may be wound around the leaf.

A third aspect of the invention comprises a method of organizing fishing flies, tied on fishing hooks, having tippets tied thereto comprises the steps of: anchoring the hook on a member centrally attached to a leaf having a length, a width, and ring reception holes along a side portion thereof; winding the tippet on the hooked fly around the leaf; and then, removably storing the leaf and fly in a ring binder.

Various other objects, advantages and features of this invention will become apparent to those skilled in the art from the following description in conjunction with the accompanying drawings.

### FIGURES OF THE INVENTION

FIG. 1 is a perspective view of a leaf for the display, storage, and organization of flies and tippets. FIG. 1 also shows a binder having removable leaf binding means adapted to facilitate insertion, removal, and variable arrangement of leaves held therein.

FIG. 2 is an enlarged portion of FIG. 1 better showing the arrangement of the fly and tippet secured by the attachment member.

FIG. 3 is a front view of a second leaf in the binder as viewed along line 2-2 on FIG. 1 showing an alternative embodiment of the invention. A fly, tied to a tippet, is hooked on a rod passing through an opening in the leaf. As above the tippet is wound around the leaf.

FIG. 4 is a cross sectional view of the second leaf in the binder as viewed along line 4-4 in FIG. 3.

The following is a discussion and description of the preferred specific embodiments of this invention, such being made with reference to the drawings, wherein the same reference numerals are used to indicate the same or similar parts and/or structure. It should be noted that such discussion and description is not meant to unduly limit the scope of the invention.

### DESCRIPTION OF THE INVENTION

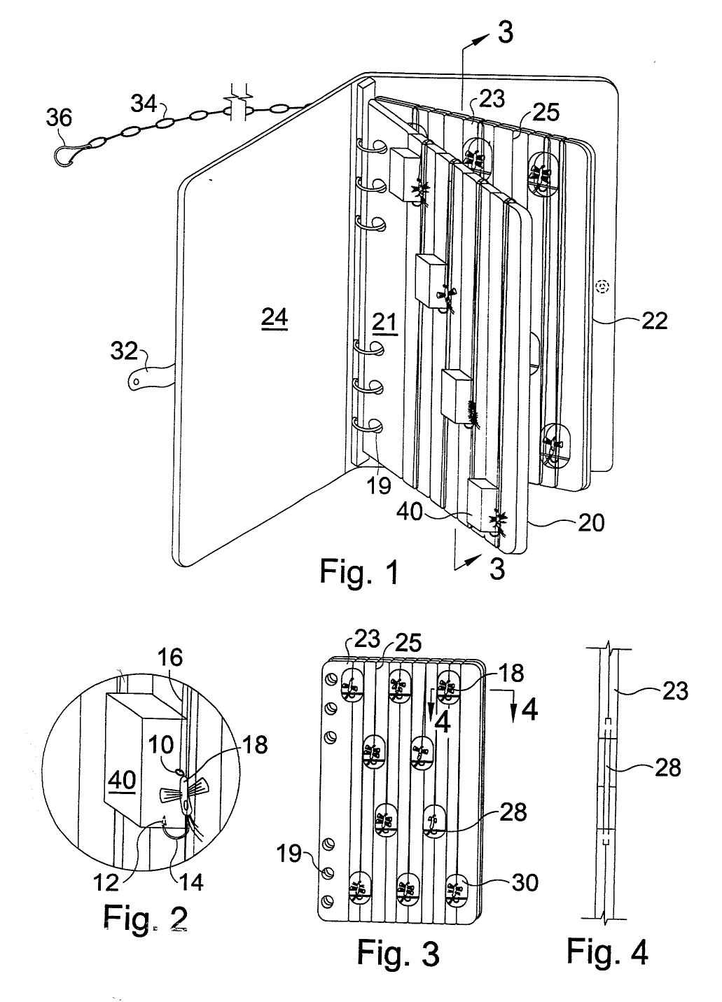

Turning now to the drawings and more particularly to FIG. 1 we have a perspective view of a first leaf 20, and a second leaf 22 both positioned in a storage binder 24 for storage, organization, and display of a fishing fly 18 and tippet 16. The first leaf 20 has a front side portion 21, a length, and a width. FIG. 2 is an enlarged partial view better showing the the fly 18 tied on a fishing hook 14 having a pointed end portion 12, and an eye 10 to which the tippet 16 is pre-tied in advance of active use.

In a preferred embodiment of the invention, the hook reception member comprises a soft plastic foam block 40 having sufficient thickness to comfortably accommodate the penetration, holding, and removal of the pointed end portion 12 of the fishing hook 14. The block 40 is adhered centrally to the front side portion 21 of the first leaf 20. The fly 18 is then first hooked into the thickness of the hook reception block 40, and then the tippet 16 may be wound around the leaf 20. Most preferably, opposite edge portions of the leaf 20 are cut 23 to receive and facilitate arranged winding of the tippet 16 therearound. Opposite edge portions 25 of the leaf 20 are cut 23 to receive and facilitate arranged winding of the tippets 16 therearound. Most preferably, the leaf 20 is generally rectangular, and the tippet 18 is wound around the length of the leaf 20.

In a preferred embodiment of the invention, there are multiple hook reception blocks 40 laterally spaced across the leaf 20 to facilitate separate vertical winding of tippets 16 around the leaf 20 through the spaces therebetween. If the blocks 40 are arranged diagonally from the top left to the bottom right of the leaf 20, then accessability is maximized. In the most preferred embodiment of the invention the leaf 20 is made of an etched plastic material to permit flies 18 and tippets 16 to be identified by writing thereon. An inner side portion of the leaf 20 is punched to facilitate storage in a ring binder 24. The ring binder 24 is adapted to facilitate insertion, removal, and variable arrangement of leaves 20 held therein.

FIG. 3 is a front view of a second leaf 22 in the binder 24 as viewed along line 2-2 on FIG. 1. FIG. 3 shows an alternative embodiment of the invention. A fly 18, tied to a tippet 16, is hooked on a hook reception member 27 which preferably is a rod 28 passing through a fly reception opening 30 in the second leaf 22. As above the tippet 16 is wound around the length of the second leaf 22. Opposite edge portions 25 of the second leaf 22 are cut to receive and facilitate arranged winding of the tippet 16 therearound. When the leaf 22 is generally rectangular, the tippet 16 is wound around the length of the leaf 22. FIG. 4 is a cross sectional view of the second leaf in the binder as viewed along line 4-4 in FIG. 3. FIG. 4 best shows how rod 28 is secured between leaves 23.

In the most preferred embodiment of the invention the leaf 22 comprises two similarly sized sheets 23 which are adhered together after positioning the hook reception member 27 therein across the fly reception opening 30 therein. Most preferably there are multiple fly reception openings 30 laterally spaced down and across the leaf to facilitate separate vertical winding of tippets 16 around the leaf 22. An inner side portion of the leaf 22 is punched to facilitate storage of the leaf in a ring binder 24.

A method of organizing fishing flies 18 on fishing hooks 14 having tippets 16 tied thereto comprises the steps of: anchoring the hook 14 on a member centrally attached to a leaf 20,22 having a length, a width, and ring reception holes 29 along a side portion thereof; winding the tippet 16 on the hooked fly 18 around the leaf 20,22; and then, removably storing the leaf 20 and fly 18 in a ring binder 24. The tippets 16 are wound around and through cuts on opposite edge portions 25 of the leaf 20 to facilitate winding of the tippet 16 therearound. The flies 18 on the leaf 20,22 may be identified by writing on the leaf 20,22. Appropriate leaves 20,22 of flies 18 for a particular fishing expedition may be organized in a binder 24 having a closure maintenance means 32, a tether 34, and an attachment means, such as a snap hook 36 for use while fishing.

While the invention has been described with preferred specific embodiments thereof, it will be understood that this description is intended to illustrate and not to limit the scope of the invention, which is defined by the following claims.

I claim:

1) A leaf for storage and display of a fishing fly and tippet, said fly tied on a fishing hook having a pointed end portion, and an eye to which the tippet is pre-tied in advance of active use, comprising:
a first leaf having a front side portion, a length and a width; and,
a hook reception member having a thickness sufficient to receive the pointed end portion of the hook, and two opposite sides, one opposite side of which is adhered to the front side portion of the first leaf;
so that the pointed end portion of the fishing hook may be first hooked into the thickness of the hook reception block, and then the tippet may be wound around the leaf.

2. A leaf as in claim 1 wherein opposite edge portions of the leaf are cut to receive and facilitate arranged winding of the tippet therearound.

3. A leaf as in claim 2 wherein the leaf is generally rectangular, and wherein the tippet is wound around the length of the leaf.

4. A leaf as in claim 3 wherein the hook reception member comprises a soft plastic foam block to accommodate the penetration, holding, and removal of the pointed end portion of the fishing hook.

5. A leaf as in claim 4 wherein there are multiple hook reception blocks laterally spaced across the leaf to facilitate separate vertical winding of tippets around the leaf through the spaces therebetween the blocks.

6. A leaf as in claim 5 wherein the blocks are arranged diagonally from the top left to the bottom right of the leaf to maximize accessability.

7. A leaf as in claim 6 wherein the leaf is made of an etched plastic material to permit the flies and tippets to be identified by writing thereon.

8. A leaf as in claim 5 wherein an inner side portion of the leaf is punched to facilitate storage in a binder.

9. A leaf as in claim 2 further comprising a ring binder adapted to facilitate insertion, removal, and variable arrangement of leaves held therein.

10) A second leaf for storage and display of a fishing fly and tippet, said fly tied on a fishing hook having a pointed end portion, and an eye to which the tippet is pre-tied in advance of active use, comprising:
a second leaf having a front side portion, a length, a width, and a thickness;
a fly reception opening cut from the front side portion through the thickness of the leaf; and,
a hook reception member extending through and across the opening so that the fishing hook may be pulled over and around the hook reception member, and then the tippet may be wound around the leaf.

11. A leaf as in claim 10 wherein opposite edge portions of the leaf are cut to receive and facilitate arranged winding of the tippet therearound.

12. A leaf as in claim 11 wherein the leaf is generally rectangular, and wherein the tippet is wound around the length of the leaf.

13. A leaf as in claim 12 wherein the leaf comprises two similarly sized sheets which are adhered together thereby positioning the hook reception member therein across the fly opening therein.

14. A leaf as in claim 13 wherein there are multiple fly reception openings laterally spaced down and across the leaf to facilitate separate vertical winding of tippets around the leaf.

15. A leaf as in claim 14 wherein an inner side portion of the leaf is punched to facilitate storage of the leaf in a ring binder.

16. A method of organizing fishing flies and tippets, said flies tied on a fishing hook having a pointed end portion, and an eye to which the tippet is pre-tied in advance of use, comprising the steps of:
anchoring the hook on a member centrally attached to a leaf having a length, a width, and ring reception holes along a side portion thereof; and
winding the tippet on the hooked fly around the leaf; and then,
removably storing the leaf and fly in a ring binder.

17. A method as in claim 16 wherein the tippets are wound around and through cuts on opposite edge portions of the leaf to facilitate winding of the tippet therearound.

18. A method as in claim 17 further comprising the steps of identifying the fishing flies on the leaf by writing on the leaf.

19. A method as in claim 17 comprising the further step of organizing the appropriate leaves of flies for a particular fishing expedition in a binder having a closure maintenance means, a tether, and an attachment means for use while fishing.
